(19) United States
(12) Patent Application Publication
(10) Pub. No.: US 2026/0106213 A1
(43) Pub. Date: Apr. 16, 2026

(54) OXIDE, METHOD FOR PRODUCING SAME, SOLID ELECTROLYTE, AND POWER STORAGE DEVICE

(71) Applicant: TOAGOSEI CO., LTD., Tokyo (JP)

(72) Inventors: Takaaki NATORI, Nagoya-shi (JP); Yasuharu ONO, Tokushima-shi (JP); Naohiko SAITO, Nagoya-shi (JP)

(73) Assignee: TOAGOSEI CO., LTD., Tokyo (JP)

(21) Appl. No.: 19/115,451

(22) PCT Filed: Sep. 20, 2023
(86) PCT No.: PCT/JP2023/034159

§ 371 Date: Mar. 26, 2025

(30) Foreign Application Priority Data
Sep. 28, 2022 (JP) 2022-154949

(51) Int. Cl. H01M 10/0562

(52) U.S. Cl. CPC H01M 10/0562; H01M 2300/0068

(57) ABSTRACT

The present invention provides a novel zirconium phosphate-based oxide exhibiting high Li conductivity and a method for producing the oxide. The present invention further provides a solid electrolyte and a power storage device using the oxide. An oxide satisfying formula (1) below: Li_{1+x+y-z}M1ₓZr₂₋ₓM2_{y}M3_{z}P_{3-y-z}O₁₂ . . . (1) (in formula (1), M1 contains Fe or In, M2 contains Si, M3 contains W, and x>0, y≥0, z≥0, and y+z>0 are satisfied).

### TECHNICAL FIELD

The present invention relates to an oxide, a method for producing the oxide, a solid electrolyte, and a power storage device.

### BACKGROUND ART

As a secondary battery, various power storage devices such as a nickel-hydride secondary battery, a lithium ion secondary battery, and an electric double layer capacitor have been put into practical use. Among them, demand for a lithium ion battery (LIB) is expanding because of its high energy density and battery capacity.

The LIB is a secondary battery that has a negative electrode, a positive electrode, and an electrolyte, and performs charge and discharge by moving lithium ions between both the electrodes via the electrolyte. Usually, an organic electrolytic solution obtained by dissolving an electrolyte salt such as LiPF₆ in a carbonate-based solvent is used as the electrolyte. However, since a combustible organic solvent is used, there is a problem that the possibility of ignition at the time of short circuit cannot be excluded. As a solution to this problem, an all-solid-state battery using a solid electrolyte having Li ion conductivity has been studied.

As the solid electrolyte having Li ion conductivity, a sulfide-based solid electrolyte, a polymer solid electrolyte, an oxide-based solid electrolyte, and the like are known. Among them, the oxide-based solid electrolyte is more excellent in stability in the atmosphere than the sulfide-based solid electrolyte, and is more excellent in Li ion conductivity than the polymer solid electrolyte. However, the oxide-based solid electrolyte is inferior in Li ion conductivity to the sulfide-based solid electrolyte, and studies on an oxide-based solid electrolyte having more excellent Li ion conductivity have been conducted.

As one type of the oxide-based solid electrolyte, oxides having a NASICON-type structure such as Li₁₊ₓAlₓTi₂₋ₓ(PO₄)₃ (hereinafter, also referred to as “LATP”), Li₁₊ₓAlₓGe₂₋ₓ(PO₄)₃ (hereinafter, also referred to as “LAGP”), and LiZr₂(PO₄)₃ (hereinafter, also referred to as “LZP”) which is zirconium phosphate are known.

It is known that LATP is reduced at a potential of 2.45 V (vs Li/Li⁺). Therefore, when used as an electrolyte, the cell voltage of the battery cannot be increased, and the energy density is limited. It is known that LAGP is less likely to be reduced than LATP, but its reduction resistance is not necessarily sufficient.

On the other hand, as disclosed in Patent Document 1, LZP has been expected as an electrolyte for an all-solid-state battery having higher reduction resistance and higher stability than LATP and LAGP.

However, LZP has a problem that Li ion conductivity is lower than that of LATP or LAGP, and has been required to be improved. So far, studies have been made on improvement of ionic conductivity of zirconium phosphate as shown in Patent Documents 2 to 4 below.

Patent Document 2 discloses an all-solid-state battery including a solid electrolyte material of which the main component is a lithium-containing zirconium phosphate-based compound (Patent Document 2 [claim 7]). It is disclosed that a lithium-containing zirconium phosphate-based compound in which at least one of phosphorus elements is substituted with a silicon element (Patent Document 2 [claim 8]) can be used, and that the triclinic LiZr₂(PO₄)₃ and the monoclinic Li_{1.3}Zr₂(P_{0.9}Si_{0.1}O₄)₃ have an activation energy Ea of 50 KJ/mol or more, and thus are more preferable (Patent Document 2 [0063]).

Patent Document 3 discloses a solid electrolyte of which the main component is a lithium-containing zirconium phosphate-based compound, and discloses that high Li ion conductivity is exhibited by substituting at least one of zirconium elements with an indium or chromium element.

Patent Document 4 discloses a solid electrolyte which is a lithium-containing phosphate compound having a cubic crystal structure. In Examples thereof, it is disclosed that zirconium phosphate doped with a specific element exhibits high Li ion conductivity.

### CITATION LIST

### Patent Literature

Patent Document 1: WO 2011/065388 A
Patent Document 2: JP-A-2015-065021
Patent Document 3: JP-A-04-160011
Patent Document 4: WO 2018/181674 A

### SUMMARY OF INVENTION

### Problems to be Solved by Invention

All of the electrolytes disclosed in Patent Documents 2, 3, and 4 can impart good Li ion conductivity, but the value thereof is insufficient as compared with the current lithium ion battery, and further improvement has been required.

The present invention has been made in view of the above circumstances, and an object thereof is to provide a novel zirconium phosphate-based oxide exhibiting high Li conductivity and a method for producing the oxide. Further, an object of the present invention is to provide a solid electrolyte and a power storage device using the oxide.

### Solution to Problems

As a result of intensive studies to solve the above problems, the present inventors have found that in an oxide based on zirconium phosphate [LiZr₂(PO₄)₃], excellent Li ion conductivity is exhibited when the Zr site is doped with Fe or In, and the P site is doped with a specific element, and have completed the present invention.

The present invention is as follows.

[1] An oxide satisfying the following formula (1).

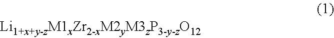

(In formula (1), M1 contains Fe or In, M2 contains Si, M3 contains W, and x, y, and z satisfy x>0, y≥0, z≥0, and y+z>0.)

[2] The oxide according to [1], satisfying x≤0.3.

[3] The oxide according to [1] or [2], satisfying y≤0.2.

[4] The oxide according to any one of [1] to [3], satisfying z≤0.2.

[5] The oxide according to any one of [1] to [4], in which M1 contains Fe.

[6] A solid electrolyte including the oxide according to any one of [1] to [5].

[7] The solid electrolyte according to [6], in which a relative density of the solid electrolyte is 80% or more.

[8] A power storage device including the solid electrolyte according to [6] or [7].

[9] A method for producing the oxide according to any one of [1] to [5], the method including:
a mixing step of mixing a plurality of supply components containing one or two or more elements of Li, the M1, the M2, the M3, Zr, and P so as to satisfy the formula (1) to obtain a mixture of the supply components; and
a firing step of firing the mixture to obtain the oxide.

The method for producing the oxide according to [9], in which layered zirconium phosphate is used as the supply components of P and Zr.

The method for producing the oxide according to [9] or [10], in which the mixing is wet mixing.

The method for producing the oxide according to any one of [9] to [11], in which the firing step includes a step of firing at 900° C. or higher.

### Effects of Invention

According to the oxide of the present invention, high lithium ion conductivity can be obtained in the zirconium phosphate-based oxide.

According to the solid electrolyte of the present invention, high lithium ion conductivity can be obtained in the zirconium phosphate-based oxide.

According to the power storage device of the present invention, the zirconium phosphate-based oxide can be used as the solid electrolyte.

According to the method for producing the oxide of the present invention, the zirconium phosphate-based oxide having high lithium ion conductivity can be obtained.

### BRIEF DESCRIPTION OF DRAWINGS

FIG. 1 is an explanatory view schematically illustrating an example (a) and another example (b) of an all-solid-state battery as a power storage device.

### DESCRIPTION OF EMBODIMENTS

Hereinafter, the present invention will be described in detail.

Unless otherwise specified, “%” means “% by mass”, “part” means “part by mass”, “ppm” means “ppm by mass”, and “numerical value X to numerical value Y” means “numerical value X or more and numerical value Y or less”. Furthermore, each embodiment described later can be an embodiment in which two or more are combined.

### [1] Oxide

The oxide of the present invention satisfies the following formula (1).

An oxide satisfying the following formula (1).

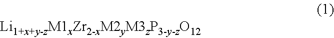

(In formula (1), M1 contains Fe or In, M2 contains Si, M3 contains W, and x, y, and z satisfy x>0, y≥0, z≥0, and y+z>0.)

That is, this oxide can be said to be an oxide based on LiZr₂(PO₄)₃ (mother structure) in which a part of Zr is substituted with M1 (including Fe or In), and a part of P is substituted with M2 (including Si) and/or M3 (including W).

In formula (1), x, y, and z are not particularly limited as long as x>0, y≥0, z≥0, and y+z>0 are satisfied.

For example, when x>0, y>0, and z=0, formula (1) is expressed as “Li_{1+x+y-z}M1ₓZr₂₋ₓM2_{y}P_{3-y}O₁₂”.

Furthermore, for example, in a case of x>0, y=0, and z>0, formula (1) is expressed as “Li_{1+x+y-z}M1ₓZr₂₋ₓM3_{z}P_{3-z}O₁₂”.

In addition, for example, in a case of x>0, y>0, and z>0, formula (1) is represented as “Li_{1+x+y-z}M1ₓZr₂₋ₓM2_{y}M3_{z}P_{3-y-z}O₁₂”.

M1 contains Fe or In. That is, an element to become a trivalent cation other than Fe or In may be contained. Examples of such an element include Group 13 elements, elements to become trivalent cations among transition elements (Group 3 to 11 elements), Sb, and Bi.

M2 contains Si. That is, an element to become a tetravalent cation other than Si may be contained.

Examples of such an element include Group 14 elements, elements to become tetravalent cations among transition elements (Group 3 to 11 elements), and Te.

M3 contains W. That is, an element to become a hexavalent cation other than W may be contained. Examples of such an element include an element to become a hexavalent cation among transition elements (Group 3 to 11 elements), and a Group 16 element.

In formula (1), x, y, and z only have to satisfy x>0, y≥0, z≥0, and y+z>0 as described above, and further preferably satisfy x≤0.3 in which more excellent Li ion conductivity can be obtained as compared with the case of x>0.3. This is considered to be because the segregation of M1 can be suppressed by satisfying x≤0.3. When the content of M1 increases, the solid solubility to the Zr site approaches the limit, an impurity phase containing a large amount of M1 starts to be formed, and the impurity phase inhibits Li ion conduction. That is, even when the α-phase having high Li ion conductivity is a dominant structure, the presence of the impurity phase inhibits Li ion conduction. For this reason, a composition in which an impurity phase is hardly formed is preferable, and from such a viewpoint, it is considered that the condition of x≤0.3 contributes. The presence or absence of the segregation of M1 can be detected by distribution measurement of M1 using energy dispersive X-ray spectroscopy.

Further, since M1 has a valence smaller than that of Zr, the electrostatic repulsive force with the Li ion which is a monovalent cation is smaller than that of Zr. Therefore, it is considered that when Zr is substituted with M1, diffusion of Li ions in the vicinity of M1 is likely to occur. On the other hand, when the M1 substitution amount increases, the effect of inhibiting Li ion conduction by trapping Li ions in the vicinity of M1 becomes remarkable. Therefore, it is considered that ion conductivity is deteriorated when the M1 substitution amount is large. From such a viewpoint, it is considered that the condition of x≤0.3 contributes.

Here, as the upper limit of x, it is more preferably to satisfy x≤0.25. Further, as the lower limit of x, it is preferable to satisfy x≥0.01, more preferable to satisfy x≥0.05, and still more preferable to satisfy x≥0.10.

Further, it is preferable to satisfy y≤0.2, in which more excellent Li ion conductivity can be obtained as compared with the case of y>0.2. Unlike M1, Si does not reach the solid solubility limit of Si even when y>0.2 (for example, y=0.3), and it is considered that segregation does not occur (the presence or absence of the segregation of Si can be detected by distribution measurement of Si using energy dispersive X-ray spectroscopy). On the other hand, in the range of 0<y≤0.2, it is observed that the α phase and/or the α′ phase is a stable phase, whereas the β phase and/or the β′ phase becomes a stable phase as the Si content increases. That is, among the four types of phases (α phase, α′ phase, β phase, and β′ phase) that can be taken by the zirconium phosphate-based oxide having the NASICON-type crystal structure, it is known that Li ion conductivity is high in the α phase, and 0<y≤0.2 can be said to be a superior condition for the α phase formation. However, when y≤0.2 and y>0.2 are compared at the same firing temperature, the latter has a higher firing temperature required for the α-phase formation. Therefore, it is considered that the disadvantage due to y>0.2 can be solved by increasing the firing temperature, but it is preferable to obtain high Li ion conductivity at a lower firing temperature from the viewpoint of energy cost at the time of production.

Further, since M2 has a valence smaller than that of P, the electrostatic repulsive force with the Li ion which is a monovalent cation is smaller than that of P. Therefore, it is considered that when P is substituted with M2, diffusion of Li ions in the vicinity of M2 is likely to occur. On the other hand, when the M2 substitution amount increases, the effect of inhibiting Li ion conduction by trapping Li ions in the vicinity of M2 becomes remarkable. Therefore, it is considered that ion conductivity is deteriorated when the M2 substitution amount is large. From such a viewpoint, it is considered that the condition of x≤0.3 contributes.

Here, as the upper limit of y, it is more preferable to satisfy y≤0.15, and still more preferable to satisfy y≤0.10. As the lower limit of y, it is preferable to satisfy y≥0.01, and more preferable to satisfy y≥0.03.

Further, it is preferable to satisfy z≤0.2, in which more excellent Li ion conductivity can be obtained as compared with the case of z>0.2. This is considered to be because the segregation of M3 can be suppressed. When the content of M3 increases, the solid solubility to the P site approaches the limit, an impurity phase containing a large amount of M3 starts to be formed, and the impurity phase inhibits Li ion conduction. That is, even when the α-phase having high Li ion conductivity is a dominant structure, the presence of the impurity phase inhibits Li ion conduction. For this reason, a composition in which an impurity phase is hardly formed is preferable, and from such a viewpoint, it is considered that the condition of z≤0.3 contributes. The presence or absence of the segregation of M3 can be detected by distribution measurement of M3 using energy dispersive X-ray spectroscopy.

Here, as the upper limit of z, it is more preferable to satisfy z≤0.15, and still more preferable to satisfy z≤0.10. As the lower limit of z, it is preferable to satisfy z≥0.01, and more preferable to satisfy z≥0.03.

In the oxide represented by formula (1), the stoichiometric ratio of O is described as 12, but in practice, the stoichiometric ratio of O may be less than 12 or may be more than 12 as long as the neutrality of the charge of the entire oxide can be maintained.

For example, when formula (1) is represented as formula (2) as described below (M1, M2, M3, x, y, and z are the same as in formula (1)),

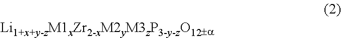

α can be, for example, 0≤α≤1.

In addition, in the oxide of the present invention, the phase structure is not limited, and as a result, an oxide having high Li ion conductivity is preferable. Among them, it is preferable to exhibit an Na Super Ionic Conductor (NASICON) type. This is because the NASICON type is superior in use as a solid electrolyte. That is, unlike the layered structure or the like, the NASICON type is useful as a solid electrolyte with a high operating voltage since a movement space of Li ions is three-dimensionally expanded, and zirconium is stable even under a high voltage.

Whether or not the oxide of the present invention exhibits the NASICON type can be determined from a diffraction profile obtained by powder X-ray diffraction measurement.

Furthermore, in the oxide of the present invention, the phase structure is not limited, but the proportion of the α phase is preferably large. This is because the zirconium phosphate-based oxide can take four phases of an α phase, an α′ phase, a β phase, and a β′ phase, but in the α phase, the crystal structure has isotropy, and thus the Li ion conductivity is the highest.

It is to be noted that which phase the oxide of the present invention exhibits can be identified by X-ray diffraction measurement. Specifically, it can be identified by measurement in Examples described later.

The relative density of the oxide of the present invention is preferably 80% or more, more preferably 85% or more, still more preferably 90% or more, and still more preferably 95% or more from the viewpoint of being able to obtain more excellent Li ion conductivity.

Here, the relative density can be obtained by measuring the diameter, thickness, and mass of the solid electrolyte, calculating the measured density from the measured values of the volume and mass, and then calculating the ratio (%) of the measured density to the theoretical density.

The use of the oxide of the present invention is not particularly limited, but for example, the oxide can be used as a material for a power storage device (a material for an all-solid-state battery, various secondary battery materials, and the like), a CO₂ sensor, or the like.

Specific examples thereof include a solid electrolyte (solid electrolyte material) of an all-solid-state battery, an electrode (electrode material) of an all-solid-state battery, and a separator.

### [2] Method for Producing Oxide

The oxide described above may be produced in any manner, may be produced using a solid phase method, or may be produced using a liquid phase method, but in the present invention, it can be produced using a solid phase method. More specifically, it can be produced by including a mixing step and a firing step.

Among the above, the mixing step is a step of mixing a plurality of supply components containing one or two or more elements of Li, the M1, the M2, the M3, Zr, and P so as to satisfy the formula (1) to obtain a mixture of the supply components. Among the above, the firing step is a step of firing the mixture to obtain an oxide.

In the present method, the supply component that supplies each element of Li, M1, M2, M3, Zr, and P may be an inorganic compound or an organic compound.

Among them, as the Li supply component, the M1 supply component (Fe supply component or In supply component), the M2 supply component (Si supply component), the M3 supply component (W supply component), and the Zr supply component, for example, carbonates, hydrogen carbonates, sulfates, sulfites, nitrates, nitrites, phosphates, acetates, citrates, ammonium salts, oxides, hydroxides, chlorides, and sulfides of these metallic elements can be used. Incidentally, these supply components may be compounds in which one kind of supply component contains two or more kinds of elements among Li, M1, M2, M3, and Zr.

On the other hand, as the P supply component, for example, a compound not containing one or two or more elements of Li, M1, M2, M3, and Zr, such as ammonium phosphate and ammonium hydrogen phosphate, can be used, but in the present invention, it is preferable to use a compound containing one or two or more elements of Li, M1, M2, M3, and Zr. In particular, in the present method, a zirconium phosphate-based compound is preferably used as a supply component (a supply component of P and Zr).

The zirconium phosphate-based compound includes zirconium hydrogen phosphate such as Zr(HPO₄)₂ and Zr(HPO₄)₂·nH₂O, zirconium phosphate such as Zr₃(PO₄) 4, and zirconium hydrogen phosphate phosphate such as Zr(PO₄)(H₂PO₄) and Zr(PO₄)(H₂PO₄)₂·nH₂O, as well as HZr₂(PO₄)₃, ZrP₂O₇, and (ZrO)₂P₂O₇. Note that n above usually satisfies 0≤n≤2 (for example, n=1, n=1.5, n=2).

In the present invention, it is particularly preferable to use Zr(HPO₄)₂·nH₂O referred to as layered zirconium phosphate. By using Zr(HPO₄)₂·nH₂O, it is possible to facilitate the recovery of the fired product (the same applies to the calcined product) after firing (the same applies to after calcination). That is, for example, the oxide of the present invention can be obtained using ZrO₂ and NH₄H₂PO₄ instead of Zr(HPO₄)₂·nH₂O, but when trying to produce the oxide of the present invention using these supply components, the shape of the fired product (the same applies to the calcined product) changes during the firing process, and the fired product (the same applies to the calcined product) adheres to the container and is difficult to be recovered, so that the handling property is poor. On the other hand, when Zr(HPO₄)₂·nH₂O is used as the supply component, the shape of the fired product (the same applies to the calcined product) hardly changes and does not adhere to the container, so that the handleability is excellent.

In the mixing step described above, a plurality of supply components containing one or two or more elements of Li, M1, M2, M3, Zr, and P is weighed so as to satisfy formula (1), that is, so as to satisfy the stoichiometric ratio of the composition represented by formula (1), and then the weighed materials are mixed.

The mixing may be performed by dry mixing, but it is preferable to perform wet mixing using a liquid. By performing the wet mixing, the density of the sintered body after firing can be increased as compared with the case of performing the dry mixing, and the Li ion conductivity can also be relatively improved. As the liquid used for wet mixing, water, various organic solvents, mixtures thereof, and the like can be appropriately used.

In the firing step, the mixture obtained in the mixing step may be fired without being molded, or may be fired after being molded.

The temperature during firing is not limited, and can be, for example, 900° C. or higher, and is preferably 1,000° C. or higher, more preferably 1,100° C. or higher, still more preferably 1,150° C. or higher, still more preferably 1200° C. or higher, and still more preferably 1,250° C. or higher. Further, the temperature can be, for example, 1,600° C. or lower, and is preferably 1,500° C. or lower, more preferably 1,400° C. or lower, still more preferably 1,350° C. or lower, and still more preferably 1,300° C. or lower.

Furthermore, the firing may be performed in one stage, or may be performed in a plurality of stages via pre-firing. That is, the temperature can be increased stepwise from a temperature lower than the firing temperature to finally impose a temperature necessary for firing. In addition, each pre-firing can be performed through a pulverization step of pulverizing the obtained pre-fired product.

When firing is performed in a plurality of stages, firing may be performed in two stages of, for example, performing first pre-firing at 1,000° C. or higher and lower than 1,150° C. and performing main firing at 1,150° C. or higher, in three stages of performing first pre-firing in a temperature range of 400° C. or higher and lower than 800° C., performing second pre-firing in a temperature range of 800° C. or higher and lower than 1,200° C., and performing firing in a temperature range of 1,200° C. or higher, or in four or more stages.

Although the firing time is not limited, for example, the pre-firing can be performed for 1 hour or more and 40 hours or less, and the main firing can be performed for 1 hour or more and 40 hours or less.

### [3] Solid Electrolyte

The solid electrolyte of the present invention contains the oxide described above.

The amount of the oxide contained in the solid electrolyte is not limited, and can be, for example, 0<X (mass %)≤100 in which X mass % is the content of the oxide when the total mass of the solid electrolyte is 100 mass %. Further, the amount can be, for example, 50≤X (mass %)≤100, and 75≤X (mass %)≤100.

The solid electrolyte of the present invention can contain other oxides which have Li ion conductivity but are not represented by formula (1). Examples of other solid electrolytes include an oxide having Li ion conductivity satisfying the following formula (3), an oxide having Li ion conductivity satisfying the following formula (4), an oxide having Li ion conductivity satisfying the following formula (5), an oxide having Li ion conductivity satisfying the following formula (6), and an oxide having Li ion conductivity satisfying the following formula (7). Only one of these compounds may be used, or two or more thereof may be used in combination.

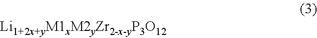

(In formula (3), M1 is a divalent metal, M2 is a trivalent metal, and x and y satisfy x≥0, y≥0, and x+y>0.)

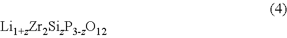

(In formula (4), z>0 is satisfied.)

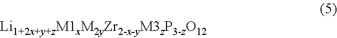

(In formula (5), M1 is a divalent metal, M2 is a trivalent metal, M3 is a tetravalent element, and x, y and z satisfy x≥0, y≥0, z>0, and x+y>0.)

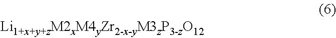

(In formula (6), M2 is a trivalent metal, M3 is a tetravalent element, M4 is a tetravalent element except Si, and x, y, and z satisfy x≥0, y≥0, z>0, and x+y>0.)

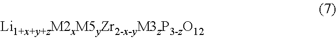

(In formula (7), M2 is a trivalent metal, M3 is a tetravalent element, M5 is a pentavalent element, and x, y, and z satisfy x≥0, y≥0, z>0, and x+y>0.)

A divalent nonmetallic element and a divalent metallic element can be applied to M1 in the above formulas (3) and (5). In addition, a trivalent nonmetallic element and a trivalent metallic element can be applied to M2 in the above formulas (3) and (5) to (7). In addition, as M3 in the above formulas (5) to (7), a tetravalent nonmetallic element and a tetravalent metallic element can be applied. Further, a tetravalent nonmetallic element except Si and a tetravalent metal element can be applied to M4 in the above formula (6). In addition, a pentavalent nonmetallic element and a pentavalent metallic element can be applied to M5 in the above formula (7).

[4] all-Solid-State Battery

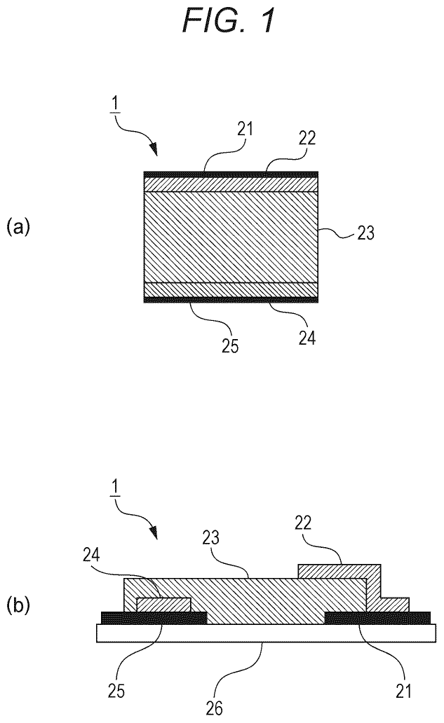

An all-solid-state battery 1 as the power storage device of the present invention includes the above-described solid electrolyte 23 (solid electrolyte layer) (see FIG. 1). Usually, the all-solid battery 1 includes a positive electrode 22 (positive electrode layer) and a negative electrode 24 (negative electrode layer) in addition to the solid electrolyte 23. The all-solid-state battery may be a bulk type (see FIG. 1(a)) or a thin film type (see FIG. 1(b)).

When the all-solid-state battery 1 is a bulk type (see FIG. 1(a)), the positive electrode 22 and the negative electrode 24 can be arranged to face each other with the solid electrolyte 23 interposed therebetween. The positive electrode 22 and the negative electrode 24 are each disposed in contact with the solid electrolyte 23. For example, the all-solid-state battery 1 can include the solid electrolyte 23, the positive electrode 22, and the negative electrode 24 as an integrated fired body. More specifically, when the solid electrolyte 23 (solid electrolyte layer) has a property of having two main surfaces, that is, when the solid electrolyte layer is a plate-like body, a membrane-like body, a sheet, a film, or the like, there can be provided a structure including the positive electrode 22 on one main surface and the negative electrode 24 on the other main surface with the solid electrolyte 23 interposed therebetween.

The positive electrode usually contains a positive electrode active material, and can additionally contain, for example, one or more of a conductive material, a solid electrolyte, a binder, and the like.

Similarly, the positive electrode usually contains a negative electrode active material, and can additionally contain, for example, one or more of a conductive material, a solid electrolyte, a binder, and the like.

Each electrode may include a current collector. That is, the positive electrode 22 can include a positive electrode current collector 21 on the surface at the side not in contact with the solid electrolyte 23. Similarly, the negative electrode 24 can include a negative electrode current collector 25 on the surface at the side not in contact with the solid electrolyte 23.

When the all-solid-state battery 1 is a thin-film type (see FIG. 1(b)), the positive electrode 22 and the negative electrode 24 can be disposed apart from each other such that a part thereof is in contact with the solid electrolyte 23. For example, the all-solid-state battery 1 can be provided as an integrated fired body in which the negative electrode 24, the solid electrolyte 23, and the positive electrode 22 are laminated in this order.

Even when the all-solid-state battery 1 is a thin film type, similarly to a bulk type, the positive electrode usually contains a positive electrode active material, and can additionally contain, for example, one or two or more of a conductive material, a solid electrolyte, a binder, and the like, and the negative electrode also usually contains a negative electrode active material, and can additionally contain, for example, one or two or more of a conductive material, a solid electrolyte, a binder, and the like. Each electrode may include a current collector.

### EXAMPLES

### <<Production of Oxide>>

### (1) Example 1

Layered zirconium phosphate (Zr(HPO₄)₂·nH₂O) (4.684 g), zirconium hydroxide (0.801 g), lithium carbonate (manufactured by FUJIFILM Wako Pure Chemical Corporation) (0.413 g), silicon dioxide (0.032 g), and iron oxide (III) (manufactured by FUJIFILM Wako Pure Chemical Corporation) (0.008 g) were weighed as supply components so as to have the molar ratio (Li:Fe:Zr:P:Si=1.06:0.01:1.99:2.95:0.05) shown in Example 1 in Table 1. The samples were charged into a mortar, and 25 g of pure water was added thereto for wet mixing to obtain a mixture.

The obtained mixture was dried at 100° C. for 2 hours and then transferred to an alumina crucible (volume: 30 mL), and the temperature was raised to 1,100° C. over 5.5 hours and held for 5 hours to perform first pre-firing. Thereafter, the mixture was allowed to cool to room temperature to obtain a first pre-fired product.

The obtained first pre-fired product was pulverized in a mortar, and 0.3 g of the obtained pulverized product of the first pre-fired product was placed in a mold having a diameter of 1.2 cm, and molded into a coin shape by applying a load of 1 t with a hydraulic press. The obtained molded product was placed on a platinum plate, heated to 800° C. over 30 minutes, further heated to 1,300° C. over 2 hours, and held for 6 hours to perform main firing. Thereafter, the product was allowed to cool to room temperature to obtain an oxide of Example 1. In Examples of the present specification, the value of n in Zr(HPO₄)₂·nH₂O is n=1.0. The same applies hereinafter.

### (2) Examples 2 to 15

In the same manner as in Example 1, predetermined samples were weighed so as to have the molar ratio shown in each of Examples 2 to 15 in Table 1. The samples were put in a mortar, and 25 g of pure water was added thereto for wet mixing to obtain a mixture. The obtained mixture was subjected to pre-firing and main firing under the same conditions as in Example 1 to obtain an oxide of each of Examples 2 to 15.

Note that in Examples 2, 3, and 5, the first pre-fired products were molded into a coin shape in the same manner as in Example 1, and then the obtained molded products were placed on a platinum plate, heated to 800° C. over 30 minutes, further heated to 1,170, 1,200, and 1,350° C. over 2 hours, respectively, and held for 6 hours to perform main firing. Thereafter, the products were allowed to cool to room temperature to obtain oxides of Examples 2, 3, and 5.

In Examples 10 to 12, indium oxide (III) (manufactured by FUJIFILM Wako Pure Chemical Corporation) was used as a raw material for indium.

In Example 15, tungsten oxide (VI) (manufactured by FUJIFILM Wako Pure Chemical Corporation) was used as a raw material of tungsten.

### (3) Comparative Example 1

Layered zirconium phosphate (Zr(HPO₄)₂·nH₂O) (4.762 g), zirconium oxide (0.778 g), and lithium carbonate (0.389 g) as supply components were weighed so as to have the molar ratio (Li:Zr:P=1.00:2.00:3.00) shown in Comparative Example 1 in Table 1. The samples were put in a mortar, and 25 g of pure water was added thereto for wet mixing to obtain a mixture. The obtained mixture was used to obtain an oxide of Comparative Example 1 in the same manner as in Example 1.

### (4) Comparative Example 2

Layered zirconium phosphate (Zr(HPO₄)₂·nH₂O) (4.777 g), zirconium oxide (0.702 g), lithium carbonate (0.410 g), and iron oxide (III) (0.042 g) were weighed so as to have the molar ratio (Li:Fe:Zr:P=1.05:0.05:1.95:3.00) shown in Comparative Example 2 in Table 1. The samples were put in a mortar, and 25 g of pure water was added thereto for wet mixing to obtain a mixture. The obtained mixture was used to obtain an oxide of Comparative Example 2 in the same manner as in Example 1.

### (5) Comparative Example 3

Layered zirconium phosphate (Zr(HPO₄)₂·nH₂O) (4.747 g), zirconium oxide (0.698 g), lithium carbonate (0.408 g), and indium oxide (III) (0.073 g) were weighed so as to have the molar ratio (Li:In:Zr:P=1.05:0.05:1.95:3.00) shown in Comparative Example 3 in Table 1. The samples were put in a mortar, and 25 g of pure water was added thereto for wet mixing to obtain a mixture. The obtained mixture was used to obtain an oxide of Comparative Example 3 in the same manner as in Example 1.

### (6) Comparative Example 4

Layered zirconium phosphate (Zr(HPO₄)₂·nH₂O) (4.681 g), zirconium oxide (0.816 g), lithium carbonate (0.409 g), and silicon dioxide (0.032 g) were weighed so as to have the molar ratio (Li:Zr:Si:P=1.05:2.00:0.05:2.95) shown in Comparative Example 4 in Table 1. The samples were put in a mortar, and 25 g of pure water was added thereto for wet mixing to obtain a mixture. The obtained mixture was used to obtain an oxide of Comparative Example 4 in the same manner as in Example 1.

### (7) Comparative Example 5

Layered zirconium phosphate (Zr(HPO₄)₂·nH₂O) (4.612 g), zirconium oxide (0.804 g), lithium carbonate (0.364 g), and tungsten oxide (VI) (0.120 g) were weighed so as to have the molar ratio (Li:Zr:W:P=0.95:2.00:0.05:2.95) shown in Comparative Example 5 in Table 1. The samples were put in a mortar, and 25 g of pure water was added thereto for wet mixing to obtain a mixture. The obtained mixture was used to obtain an oxide of Comparative Example 5 in the same manner as in Example 1.

### <<Description of Evaluation Method>>

### (1) Measurement of Relative Density

The relative densities of the oxides of Examples 1 to 15 and Comparative Examples 1 to 5 were calculated, and the results are shown in Table 1. The calculation method is as follows.

The diameter, thickness, and mass of the oxide produced above were measured, and the measured density was calculated from the measured values of the volume and mass. Then, the relative density was calculated by calculating the ratio (%) of the measured density to the theoretical density.

### (2) Identification of Crystal Phase

Identification of the main crystal phases of the respective oxides of Examples 1 and 15 and Comparative Examples 1 to 5 was performed by X-ray diffraction (XRD) measurement, and is also shown in Table 1. The XRD measurement conditions are as follows.
X-ray diffraction measurement apparatus: D8 ADVANCE manufactured by Bruker AXS
Characteristic X-ray: CuKα
Measurement voltage: 40 kV
Measurement current: 40 mA
Measurement method: continuous
Measurement range: 10°≤2θ≤80°
Step side: 0.01°
Scan speed: 2.5°/min

Then, the crystal phases generated in the oxides of Examples 1 to 15 and Comparative Examples 1 to 5 were identified using the data of ICSD: 201935 (α phase), ICSD: 89456 (α′ phase), ICSD: 91113 (B phase), and ICSD: 91112 (β′ phase), which are the crystal phase data of LiZr₂(PO₄)₃ stored in the inorganic crystal structure database (ICSD), and the analysis software (product name “DIFFRAC.TOPAS” manufactured by BRUKER). The results thereof are also shown in Table 1.

In Table 1, the notation “a” indicates that the main crystal phase is the α phase, and the notation “B” indicates that the main crystal phase is the β′ phase.

### (3) Evaluation of Ion Conductivity

### (3-1) Formation of Current Collector Layer

Each of the oxides (coin-shaped sintered pellets) obtained in Examples 1 to 15 and Comparative Examples 1 to 5 described above was masked with a polyimide tape such that a circular exposed surface having a diameter of 6 mm was formed at the center of each of both surfaces. Thereafter, a current collector layer was formed on the exposed surface by sputtering. The current collector layer was formed as a gold (Au) layer having a thickness of about 50 nm. A gold vapor deposition apparatus (Ion coater IB-2/IB-3 manufactured by EIKOHSHA) was used for sputtering.

### (3-2) Measurement of AC Impedance

In the above (3-1), the AC impedance of each oxide of Examples 1 to 15 and Comparative Examples 1 to 5 in which the current collector layer was formed was measured, and a complex impedance plot was created. In Examples 1 and 15 and Comparative Examples 1 to 5, measurement was performed at a frequency of 20 Hz to 120 MHz, a voltage of 10 mV, a temperature of 25° C. or a frequency of 1 Hz to 1 MHz, a voltage of 10 mV, and a temperature of 25° C. using an impedance analyzer (model “E4990A” manufactured by Keysight Technologies) or a multipotentiostat/galvanostat (model “VMP3” manufactured by BioLogic Corporation) equipped with a frequency response analyzer (FRA).

### (3-3) Calculation of Ion Conductivity

The value of the terminal at the right end of the arc in the complex impedance plot obtained in (3-2) above was defined as the resistance R (sum of the bulk resistance and the grain boundary resistance) of each oxide, and the ion conductivity σ (Li ion conductivity) was calculated using the following formula. The results are shown in Table 1.

$$σ = ( t / A ) \times ( 1 / R )$$

$$σ : ion conductivity$$

$$t : thickness of sample$$

$$A : area of electrode$$

$$R : resistance of oxide$$

### (3-4) Calculation of Bulk Ion Conductivity

In an example in which waveforms of two arcs were observed in the complex impedance plots of Examples 1 to 15 and Comparative Examples 1 to 5 obtained in the above (3-2), the diameter of the first arc was set as the bulk resistance (Rb), and the bulk ion conductivity σb (bulk Li ion conductivity) was calculated using the following formula. The results are shown below and also shown in Table 1.

$$σ b = ( t / A ) \times ( 1 / Rb )$$

$$σ : ion conductivity$$

$$t : thickness of sample$$

$$A : area of electrode$$

$$Rb : bulk resistance$$

TABLE 1

| | | | | | | | | | | | | Evaluation results | |
|---|---|---|---|---|---|---|---|---|---|---|---|---|---|
| | | Oxide | | | | | | | | | | | Intragranular |
| | | [Li] | | | | | | | Main firing | | Main | Li ion | Li ion |
| | | 1 + x + | [Fe] | [In] | [Zr] | [Si] | [W] | [P] | temperature | Relative | crystal | conductivity | conductivity |
| | | y − z | x | x | 2 − x | y | z | 3 − y − z | (° C.) | density | phase | (S/cm) | (S/cm) |
| Example | 1 | 1.06 | 0.01 | — | 1.99 | 0.05 | — | 2.95 | 1,300 | 85 | α | 9.2.E−06 | 1.3.E−04 |
| | 2 | 1.10 | 0.05 | — | 1.95 | 0.05 | — | 2.95 | 1,170 | 74 | α | 9.9.E−06 | 1.8.E−04 |
| | 3 | 1.10 | 0.05 | — | 1.95 | 0.05 | — | 2.95 | 1,200 | 79 | α | 1.4.E−05 | 2.2.E−04 |
| | 4 | 1.10 | 0.05 | — | 1.95 | 0.05 | — | 2.95 | 1,300 | 87 | α | 4.9.E−05 | 4.0.E−04 |
| | 5 | 1.10 | 0.05 | — | 1.95 | 0.05 | — | 2.95 | 1,350 | 91 | α | 3.2.E−05 | 3.5.E−04 |
| | 6 | 1.15 | 0.10 | — | 1.90 | 0.05 | — | 2.95 | 1,300 | 90 | α | 6.9.E−05 | 4.8.E−04 |
| | 7 | 1.20 | 0.15 | — | 1.85 | 0.05 | — | 2.95 | 1,300 | 91 | α | 7.6.E−05 | 5.8.E−04 |
| | 8 | 1.25 | 0.20 | — | 1.80 | 0.05 | — | 2.95 | 1,300 | 89 | α | 1.2.E−05 | 3.6.E−04 |
| | 9 | 1.35 | 0.30 | — | 1.70 | 0.05 | — | 2.95 | 1,300 | 87 | α | 9.0.E−06 | 1.8.E−04 |
| | 10 | 1.10 | — | 0.05 | 1.95 | 0.05 | — | 2.95 | 1,300 | 87 | α | 1.6.E−05 | 8.7.E−05 |
| | 11 | 1.25 | — | 0.20 | 1.80 | 0.05 | — | 2.95 | 1,300 | 89 | α | 7.3.E−05 | 3.2.E−04 |
| | 12 | 1.20 | 0.10 | 0.05 | 1.85 | 0.05 | — | 2.95 | 1,300 | 90 | α | 9.2.E−06 | 4.4.E−04 |
| | 13 | 1.08 | 0.05 | — | 1.95 | 0.03 | — | 2.97 | 1,300 | 88 | α | 9.8.E−06 | 1.6.E−04 |
| | 14 | 1.25 | 0.05 | — | 1.95 | 0.20 | — | 2.80 | 1,300 | 84 | α | 9.0.E−06 | 3.9.E−04 |
| | 15 | 1.00 | 0.05 | — | 1.95 | — | 0.05 | 2.95 | 1,300 | 80 | α | 8.5.E−06 | 1.5.E−04 |
| Comparative | 1 | 1.00 | — | — | 2.00 | — | — | 3.00 | 1,300 | 67 | β′ | 6.2.E−08 | — |
| Example | 2 | 1.05 | 0.05 | — | 1.95 | — | — | 3.00 | 1,300 | 90 | α | 7.2.E−06 | 9.7.E−05 |
| | 3 | 1.05 | — | 0.05 | 1.95 | — | — | 3.00 | 1,300 | 74 | α | 6.5.E−06 | 5.7.E−05 |
| | 4 | 1.05 | — | — | 2.00 | 0.05 | — | 2.95 | 1,300 | 69 | β′ | 1.6.E−07 | — |
| | 5 | 0.95 | — | — | 2.00 | — | 0.05 | 2.95 | 1,300 | 65 | β′ | 5.6.E−08 | — |

### <<Evaluation Results>>

As is apparent from the results of Examples 1 to 15, the oxide of the present invention was excellent in Li ion conductivity.

Among them, focusing attention on the element with which Zr is doped, the case of being doped with Fe (Examples 1, 4, and 6 to 9) demonstrated the result that the Li ion conductivity was further excellent as the substitution ratio x approached 0.15.

Further, when Zr was doped with In (Examples 10 and 11), the Li ion conductivity was maximized at the substitution ratio x of 0.20.

Furthermore, focusing attention on the main firing temperature (Examples 2 to 5), the result was that the ion conductivity was the best in the firing at 1,300° C.

On the other hand, the Li ion conductivity of each oxide in the cases of no doping (Comparative Example 1), doping of only Zr(Comparative Examples 2 and 3), and doping of only P (Comparative Examples 4 and 5) was lower than that in Examples 1 to 15, and results inferior in practicability were obtained.

From the above results, it was found that by doping both Zr and P with the specific elements of the present invention, higher Li ion conductivity is exhibited.

### LIST OF REFERENCE SIGNS

1 All-solid-state battery
21 Current collector (positive electrode current collector)
22 Positive electrode
23 Solid electrolyte
24 Negative electrode
25 Current collector (negative electrode current collector)
26 Substrate

1. An oxide satisfying formula (1) below: 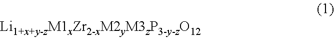
(in formula (1), M1 contains Fe or In, M2 contains Si, M3 contains W, and x>0, y≥0, z≥0, and y+z>0 are satisfied).

2. The oxide according to claim 1, wherein x≤0.3 is satisfied.

3. The oxide according to claim 1, wherein y≤0.2 is satisfied.

4. The oxide according to claim 1, wherein z≤0.2 is satisfied.

5. The oxide according to claim 2, wherein the M1 contains Fe.

6. A solid electrolyte comprising the oxide according to claim 1.

7. The solid electrolyte according to claim 6, wherein a relative density of the solid electrolyte is 80% or more.

8. A power storage device comprising the solid electrolyte according to claim 7.

9. A method for producing the oxide according to claim 1, the method comprising:
a mixing step of mixing a plurality of supply components containing one or two or more elements of Li, the M1, the M2, the M3, Zr, and P so as to satisfy the formula (1) to obtain a mixture of the supply components; and
a firing step of firing the mixture to obtain the oxide.

10. The method for producing the oxide according to claim 9, wherein layered zirconium phosphate is used as the supply components of P and Zr.

11. The method for producing the oxide according to claim 9, wherein the mixing is wet mixing.

12. The method for producing the oxide according to claim 9, wherein the firing step includes a step of firing at 900° C. or higher.
